(19) United States
(12) Patent Application Publication
(10) Pub. No.: US 2025/0237865 A1
(43) Pub. Date: Jul. 24, 2025

(54) HEAD-UP DISPLAY DEVICE

(71) Applicant: EYELIGHTS, LABEGE (FR)

(72) Inventors: Patrice NAGTEGAELE, ESCALQUENS (FR); Romain DUFLOT, CASTANET TOLOSAN (FR); Quentin AILLOUD, VARENNES (FR)

(21) Appl. No.: 18/849,384

(22) PCT Filed: Mar. 23, 2023
(86) PCT No.: PCT/EP2023/057414

§ 371 Date: Sep. 20, 2024

(30) Foreign Application Priority Data
Mar. 24, 2022 (FR) FR2202639

(51) Int. Cl. G02B 27/01

(52) U.S. Cl. CPC G02B 27/0101; G02B 27/0149; G02B 2027/015

(57) ABSTRACT

The present invention relates to a head-up display device (12) for a vehicle (10) with a handlebar (14), comprising:
a. a support (20), at least a portion of the support (20), called the useful portion (24), being partially reflective and having a non-zero curvature so as to form a concave mirror on the rider's side (16),
b. an emission unit for vehicle control information (10), the emission unit and the support (20) being positioned in the display device according to positioning constraints, the positioning constraints being such that:
   1. the light beam emitted by the emission unit is reflected onto the useful portion (24) of the support (20) so as to form a virtual image in the field of vision of the rider (16) in the driving position, and
   2. the virtual image formed is the same image for the right eye and the left eye of the rider (16).

The present invention relates to a head-up display device for a vehicle with a handlebar. The present invention further relates to an associated device and an associated design method.

Vehicles with handlebars, such as motorcycles or scooters, are usually equipped with a control panel at the handlebars of the vehicle. Such a control panel, also called an instrument cluster or dashboard, serves to show the rider information useful for driving and operating the vehicle. For this purpose, the control panel comprises the on-board instruments of the vehicle, some of which are required by law.

Nevertheless, to view the control panel, the rider has to take his/her eyes off the road, which reduces alertness and increases eye fatigue by the constantly required visual accommodation effort.

In the automotive field, it is known to use head-up displays to enable useful information to be viewed more safely.

However, vehicles with handlebars, such as motorcycles or scooters, have constraints in terms of available space (particularly for small-cylinder vehicles) and rider positioning, with, and furthermore, depending on the case, a field of vision restricted by the wear of a helmet. Such constraints are incompatible with head-up displays used for motor vehicles.

Documents JP S59 172086 U and EP 3 076 221 A relate to examples of display devices of the prior art.

There is thus a need for a device compatible with the constraints of vehicles with handlebars, making it easier for the rider to see information useful for controlling the vehicle so as to improve driving, safety and keeping the rider vigilant.

For this purpose, the present description relates to a head-up display device for a vehicle with a handlebar, such as a motorcycle or scooter, comprising:
a. a support suitable for being positioned opposite the upper part of the body of a rider in the driving position so as to deflect the air when driving the vehicle, at least a portion of the support, called the useful portion, being partially reflective and having a non-zero curvature so as to form a concave mirror on the rider's side,
b. An emission unit for vehicle control information, the emission unit being apt to emit at least one light beam, the emission unit having at least one operating mode, referred to as the head-up display mode,
the emission unit and the support being positioned in the display device according to positioning constraints, the positioning constraints being such that, in the head-up display mode:
the light beam emitted by the emission unit is reflected onto the useful portion of the support so as to form a virtual image in the field of vision of the rider in the driving position, and
the virtual image formed is the same image for the right eye and the left eye of the rider.

According to other advantageous aspects, the device comprises one or a plurality of the following features, taken individually or according to all technically possible combinations:
the support has an inclination, called the main inclination, with respect to the vertical, the emission unit being inclined relative to the support by an inclination, called the relative inclination, the positioning constraints stipulating that the main inclination and the relative inclination are such that the light beam emitted by the emission unit and reflected onto the useful portion forms a virtual image in the field of vision of the rider in the driving position;
the concave mirror has a vertex and a focus, the positioning constraints stipulating that the emission unit is positioned on the rider side in a zone between the vertex of the concave mirror and a reference point, the positioning constraints stipulating that the reference point is a point between the vertex and the focus of the concave mirror positioned on the straight line connecting the vertex and the focus of the concave mirror so that the virtual image formed in the field of vision of the rider in the driving position is the same image for the right eye and the left eye of the rider;
the concave mirror has a radius of curvature, the position of the reference point depending on the radius of curvature of the concave mirror;
the distance between the reference point and the vertex of the concave mirror is called the useful distance, the positioning constraints stipulating that the useful distance satisfies the following relation:

$$d = - A . {R}^{2} + B . R + C$$

Where:
   d is the useful distance,
   R is the radius of curvature of the concave mirror, and
   A, B and C are positive numbers;
the concave mirror has a radius of curvature, the radius of curvature being such that the virtual image has a magnification strictly greater than one;
the emission unit has another mode of operation, called the direct display mode, such that the information emitted by the emission unit is directly readable by the rider on the emission unit when the rider in the driving position is looking at the emission unit;
the direct display mode and the head-up display mode correspond to different relative inclinations of the emission unit with respect to the support;
the display device comprises a pivoting mechanism apt to pivot the emission unit between the head-up display mode and the direct display mode.

The present description further relates to a driving assembly comprising:
a. a vehicle with a handlebar, such as a motorcycle or scooter, and
b. a display device as described hereinabove, the display device being integrated into the vehicle so as to be positioned opposite the upper part of a rider's body in the driving position to deflect air when driving the vehicle and to serve for the display of vehicle control information by forming a virtual image in the field of vision of the rider in the driving position, the virtual image formed being the same image for the right eye and the left eye of the rider.

The present description further relates to a method of designing a display device as described hereinabove for a vehicle with a handlebar, such as a motorcycle or scooter, the method comprising the following steps:
a. obtaining rider features relating to a rider in the driving position in the vehicle,
b. supplying a support suitable for being positioned opposite the upper part of the body of a rider in the driving position, at least a portion of the support, known as the useful portion, being partially reflective and having a non-zero curvature so as to form a concave mirror on the rider's side, the curvature of the support having been determined according to the features of the rider,
c. supplying an emission unit for vehicle control information, the emission unit being apt to emit at least one light beam, the emission unit having at least one operating mode, called the head-up display mode, and
d. positioning the support and the emission unit in the display device according to positioning constraints, the positioning constraints being such that, in the head-up display mode, the light beam emitted by the emission unit is reflected onto the useful portion so as to form a virtual image in the field of vision of the rider in the driving position, the virtual image formed being the same image for the right eye and the left eye of the rider.

Other features and advantages of the invention will appear upon reading the following description which follows embodiments of the invention, given only as a limiting example, and making reference to the following drawings:

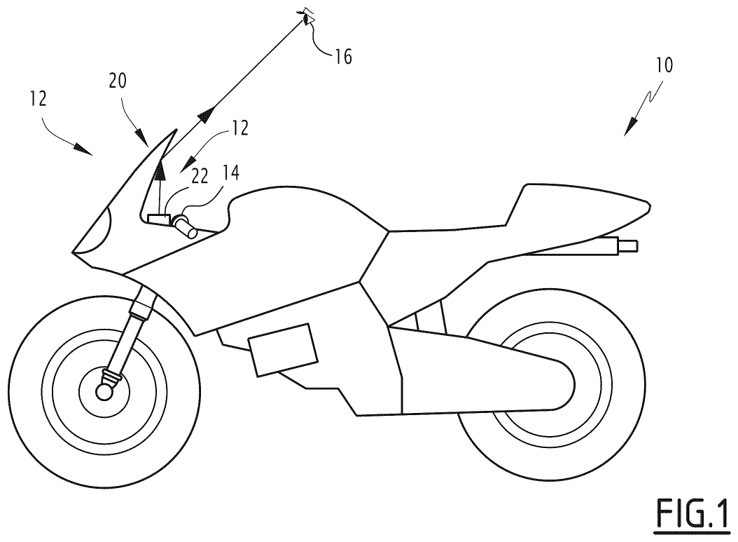

FIG. 1 is a schematic representation of an example of vehicle with a handlebar comprising a head-up display device,

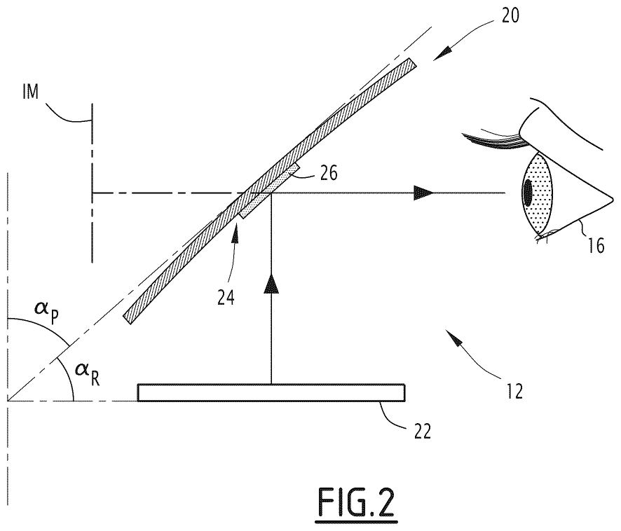

FIG. 2 is a schematic representation of an example of a head-up display device comprising a support and an emission unit for displaying information,

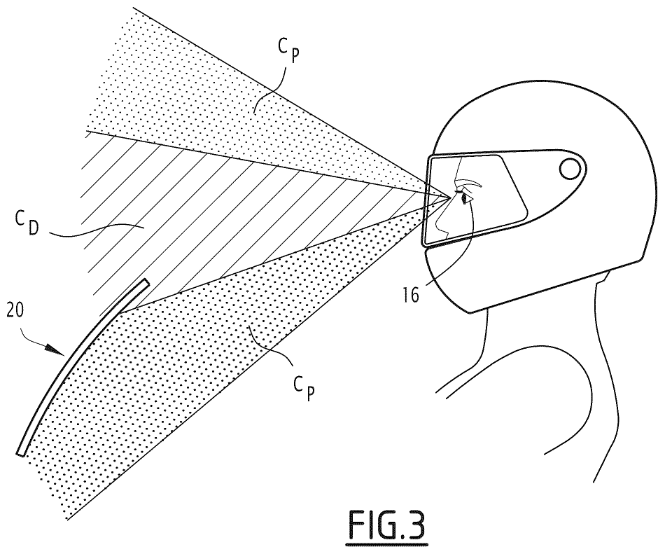

FIG. 3, a schematic representation illustrating an example of the field of vision of a rider wearing a helmet, more particularly of the direct field of vision and of the peripheral field of vision,

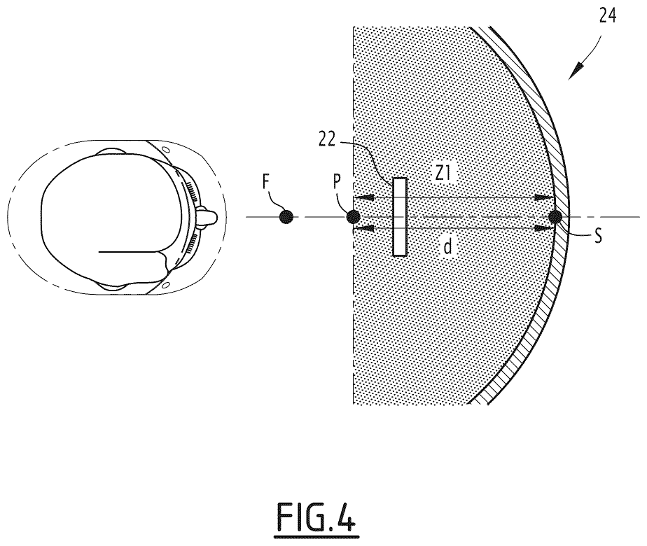

FIG. 4, a schematic representation illustrating an example of positioning constraints of the support and of the emission unit,

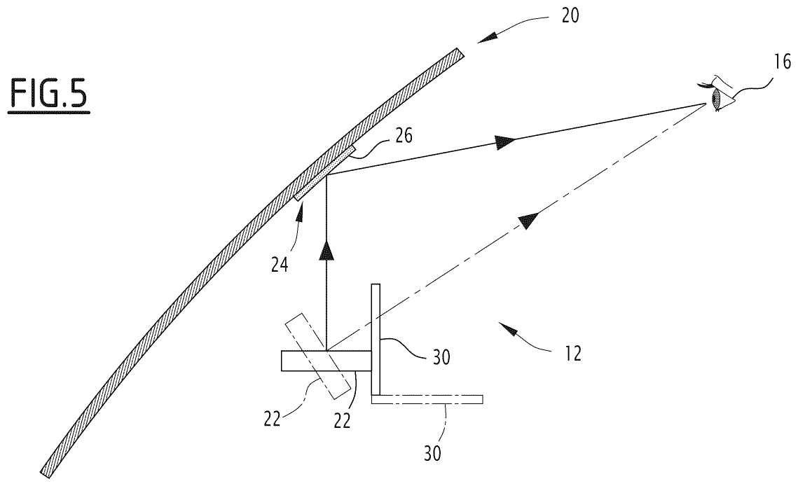

FIG. 5, a schematic representation of another example of a head-up display device, the example illustrating two modes of operation of the information emission unit of the display device, namely a head-up display mode and a direct display mode, and

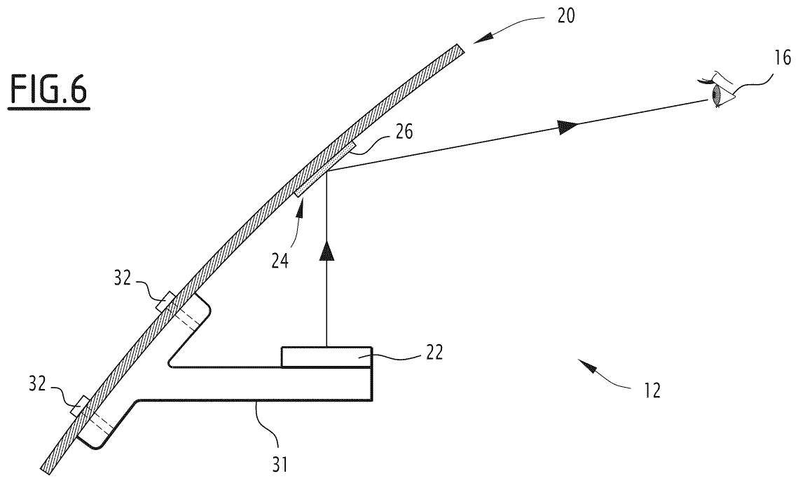

FIG. 6, a schematic representation of another example of a display device, the support and the emission unit being secured to each other to form one and the same unit.

A vehicle 10 comprising a head-up display device 12 is shown in FIG. 1.

In said example, the vehicle 10 is a motorcycle.

In a variant, the vehicle 10 is a scooter, a quad, a sidecar, a gyropod, a moped, a motorcycle or else a bicycle, a tricycle or a cargo tricycle.

More generally, the 10 vehicle is any vehicle with a handlebar 14. A handlebar is a member apt to orient the front wheel or wheels of the vehicle 10 so as to control the trajectory. A handlebar thereby differs from the steering wheel of a motor vehicle.

It should be noted that, given the preceding examples, the vehicle 10 is different from a motor vehicle or rail vehicle. Such a vehicle 10 may or may not be motorized and may or may not be equipped with a saddle. Such a vehicle 10 has between two and four wheels.

The device 12 is suitable for displaying information for controlling the vehicle 10 to a rider 16 when the vehicle 10 is being driven by the rider 16. Such control information is e.g. navigation, safety or communication information coming from an on-board system in the vehicle or from an electronic device of the rider, such as a smartphone.

The device 12 comprises at least one operating mode making possible the display of information in the field of vision of the rider 16 of the vehicle 10 during driving. The information is e.g. provided by on-board instruments of the vehicle 10 or else is navigation, safety or communication information coming from a system on-board the vehicle or from an electronic device of the rider, such as a smartphone.

As an example, the information relates to a speed indicator of the vehicle 10, to the energy consumption of the vehicle 10, to alarms relating to the malfunction of certain components of the vehicle 10 or to navigation information (mapping, positions, directions).

As illustrated in FIG. 2, the device 12 comprises a support 20 and an emission unit 22 for the control information of the vehicle 10.

The support 20 is apt to be positioned opposite the upper part of the body (at least part of the torso) of the rider 16 in the driving position so as to deflect the air during the driving of the vehicle 10. The support 20 thereby has the function of a windscreen. Same is also called a deflector or bubble.

The support 20 is transparent or partially transparent (entirely or partially tinted) or opaque.

The support 20 is made e.g. of polycarbonate.

The support 20 has at least one portion, called the useful portion 24, which is partially reflective, and which has a non-zero curvature so as to form a concave mirror on the rider's side. The concave mirror has an apex S, a focus F and a radius of curvature R.

In an example of embodiment, as illustrated by FIG. 2, the useful portion 24 is covered with a reflector element 26 imparting the partially reflective function. The reflector element 26 is e.g. a coating or a treatment (e.g. obtained by physical deposition or chemical deposition) or a film (e.g. laminated or held by electrostatic effect).

In a variant, the reflector element 26 is inside the useful portion 24.

In the example shown in FIG. 2, the support 20 has a non-zero curvature, and the useful portion 24 has a curvature uniform with the curvature of the support 20 (same axes of curvature). In a variant, the useful portion 24 is a local deformation of the support 20.

In the example shown in FIG. 2, the useful portion 24 extends over only a portion of the support 20, in the present case a portion serving to generate a virtual image in the (direct or peripheral) field of vision of the rider in the driving position, as will be explained hereinafter. In a variant, the useful portion 24 extends over the entire support 20.

The emission unit 22 is suitable for displaying control information for the vehicle 10. The information preferably comprises information supplied by on-board instruments of the vehicle 10 or else navigation, safety or communication information coming from a system on-board the vehicle or from an electronic device of the rider, such as a smartphone. To this end, the emission unit 22 is apt to emit at least one light beam.

The emission unit 22 has at least one operating mode, called the head-up display mode. Preferably, in the head-up display mode, the head-up display device has a shutter 30 (visible in FIG. 5) which can mask, from the direct vision of the rider, the light beam emitted by the emission unit 22. Thereby, when the emission unit 22 is a screen, in the head-up display mode, the image displayed on the emission unit 22 is not visible to the rider in direct vision. The emission unit 22 and the support 20 are positioned in the display device 12 according to positioning constraints.

The positioning constraints are such that, in the head-up display mode:
the light beam emitted by the emission unit 22 is reflected onto the useful portion 24 so as to form a virtual image IM in the field of vision of the rider 16 in the driving position, and
the virtual image IM formed is the same image for the right eye and the left eye of the rider 16.

The positioning constraints thereby allow the virtual image IM formed to be in the field of vision of the rider 16 in the driving position, and to prevent the phenomenon of left eye-right eye double image. The field of view considered is preferably the direct field of view C_{D} (also called the central field of view), if not at least the peripheral field of view C_{P}. The direct field of vision C_{P} is a zone of space (cone of vision) located in the center of a rider's field of vision. The peripheral field of vision C_{P} is the remaining portion of the rider's field of vision. FIG. 3 illustrates, as an example, the different fields of vision for a rider with a helmet e.g. a motorcycle rider or a scooter rider.

In one embodiment, the positioning constraints define the absolute position of the support 20 and the relative position of the emission unit 22 with respect to the support 20.

In the following, as illustrated in FIG. 2, a main inclination α_{P} is defined as being the inclination of the support 20 with respect to the vertical. A relative inclination α_{R} is also defined as being the relative inclination of the emission unit 22 with respect to the medium 20.

In the example of embodiment, the positioning constraints stipulate that the main inclination α_{P} and the relative inclination α_{R} are such that the light beam emitted by the emission unit 22 and reflected onto the useful portion 24 forms a virtual image IM in the field of vision of the rider 16 in the driving position.

More particularly, as illustrated in FIG. 4, the positioning constraints stipulate that the emission unit 22 is positioned on the rider side 16 in a zone Z1 between the vertex S of the concave mirror and a reference point P. The positioning constraints stipulate that the reference point P is a point situated between the vertex S and the focus F of the concave mirror positioned on the straight line connecting the apex S and the focus F of the concave mirror so that the virtual image IM formed in the field of vision of the rider 16 in the driving position is the same image for the right eye and the left eye of the operator 16. Thereby, beyond the zone Z1, because of the non-zero curvature of the useful portion 24, an image specific to each eye will be obtained, hence a phenomenon of double image.

Preferably, the position of the reference point P depends on the radius of curvature R of the concave mirror.

Advantageously, the positioning constraints stipulate that the distance between the reference point P and the vertex S of the concave mirror, called the useful distance d, satisfies the following relation:

$$d = - A . {R}^{2} + B . R + C$$

Where:
   d is the useful distance,
   R is the radius of curvature of the concave mirror, and
   A, B and C are positive numbers.

The distance d thereby defines the maximum position not to be exceeded in order to avoid a different image for each eye. The display device is then positioned between S and P.

The preceding relations was obtained experimentally. In one embodiment, the coefficient A is equal to 0.0009, the coefficient B is equal to 0.228 and the coefficient C is equal to 2.7046.

Preferably, the radius of curvature R of the concave mirror is such that the virtual image IM has a magnification strictly greater than one, preferably greater than or equal to 1.5.

Preferably, no optical components are arranged between the emission unit 22 and the support 20.

As an optional addition, as illustrated in FIG. 5, the emission unit 22 has another operating mode, called the direct display mode. The direct display mode is such that the information emitted by the emission unit 22 is directly readable by the rider 16 on the emission unit 22 when the rider 16 in the driving position is looking at the emission unit 22. More particularly, in the direct display mode, the light beam emitted by the emission unit 22 is not reflected onto the useful portion 24 of the concave mirror.

Preferably, as illustrated in FIG. 5, the direct display mode and the head-up display mode correspond to different relative inclinations of the emission unit 22 with respect to the support 20. In particular, in the head-up display mode, the light beam emitted by the emission unit 22 is apt to be reflected onto the useful portion 24 of the support 20 so as to form a virtual image IM. In the direct display mode, the light beam emitted by the emission unit 22 is emitted in the direction of the rider 16.

Furthermore, it should be noted that when the display device 12 comprises a shutter 30, the position of the shutter 30 being modified between the head-up display mode and the direct display mode (thus according to the inclination of the emission unit 22) such that the direct image from the emission unit 22 is masked from the rider in the head-up display mode and is visible to the rider in the direct display mode.

Thereby, in the direct display mode, the emission unit 22 can be considered to be a dashboard for the vehicle 10. It could thus even be envisaged to eliminate the dashboard of the vehicle.

Preferably, the display device 12 comprises a pivoting mechanism, such as a pivot, apt to pivot the emission unit 22 between the head-up display mode and the direct display mode. The pivoting mechanism is e.g. a pivot, a curved slide or corresponds to curvilinear guiding, or else a specific kinematics.

Preferably, the direct display mode and the head-up display mode also correspond to different brightness levels (brighter for the head-up display mode) and to a different orientation of the (real) image generated by the emission unit 22 (reversed image for head-up display mode and not reversed image for the direct display mode).

Preferably, the emission unit 22 is a screen suitable for displaying a real image from which the light beam coming from the emission unit 22 is emitted. The display is e.g. a liquid crystal display (LCD) or an organic light emitting diode (OLED) display.

In a variant, the emission unit 22 comprises a single operating mode, which is the head-up display mode, and the emission unit 22 is fixed relative to the support 20. In such variant, the vehicle 10 generally comprises a dashboard different from the display device 12 for displaying information coming from the on-board instruments.

Preferably, as illustrated in the embodiment of FIG. 6, the support 20 and the emission unit 22 form a single unit suitable for being mounted in the vehicle 10. The emission unit 22 is then secured to the support 20. As a result, it is easier to mount the display device 12 on the vehicle 10.

More particularly, in the example shown in FIG. 6, the display device 12 comprises a holding element 31 on which the emission unit 22 is fastened. The holding element 31 is as such fastened to the support 20 by fasteners 32. Such a device is thereby intended to be marketed as a single unit as an accessory for a handlebar vehicle, and then to be fitted by the manufacturer or the purchaser in the vehicle.

An example of design method for a head-up display device 12 as described hereinabove, will now be described.

The design method comprises a step of obtaining features relating to a rider 16 in the driving position in the vehicle 10. The features correspond e.g. to an average rider, e.g. corresponding to the 85^{th} percentile of the population. The features are e.g. the position of the rider in the vehicle 10 or the direction gaze of the rider in the driving position.

The design method comprises a step of providing a support 20 apt to be positioned opposite the upper part of the body of a rider 16 in the driving position.

At least one portion of the support 20, called the useful portion 24, is partially reflective and has a non-zero curvature so as to form a concave mirror on the rider's side. The position of the useful portion 24 and the curvature of the support 20 were determined e.g. depending on the features of the rider.

The design method comprises a step of supplying an emission unit 22 for the control information of the vehicle 10. The emission unit 22 is apt to emit at least one light beam, the emission unit 22 has at least one operating mode, called the head-up display mode.

The design method comprises a step of positioning the support 20 and the emission unit 22 in the display device 12 according to positioning constraints. The positioning constraints are such that, in the head-up display mode, the light beam emitted by the emission unit 22 is reflected onto the useful portion 24 so as to form a virtual image IM in the field of vision of the rider 16 in the driving position, the virtual image IM formed being the same image for the right eye and the left eye of the rider 16.

More particularly, the positioning constraints are as described hereinabove in the description.

In one example, the position of the support 20 is first determined with respect to the vertical. The relative inclination α_{R} of the emission unit 22 with respect to the support 20 is then determined so that the virtual image IM is well formed in the field of vision of the rider 16 in the driving position. The zone wherein to position the emission unit 22 with respect to the support 20 is also determined as described hereinabove as a function of the curvature of the useful portion 24 so that the virtual image IM formed is the same image for the right eye and the left eye of the rider 16.

Thereby, the head-up display device 12 serves for the display of information useful for driving (control, navigation, traffic conditions information) in the field of vision of a rider 16 in the driving position, which facilitates the access of the rider to such information.

More particularly, the non-zero curvature of the useful part 24 makes it possible to enlarge the information coming from the emission unit 22, which makes it possible to dispense with an emission unit 22 that is too bulky for a handlebar vehicle. Furthermore, such a curvature contributes to reducing vibrations (all the more so when the curvature extends over the entire support 20) which are generally more significant for handlebar vehicles than for motor vehicles.

The positioning constraints make it possible, in particular, that despite the curvature of the useful portion 24, the virtual image IM generated is the same for each of the two eyes of the rider 16, and thereby prevents the inconvenience associated with a double image.

A person skilled in the art would understand that the embodiments described hereinabove are likely to be combined with one another when such combinations are compatible.

1. A head-up display device (12) for a vehicle (10) with a handlebar (14), such as a motorcycle or a scooter, comprising:
a. a support (20) suitable for being positioned opposite the upper part of the body of a rider (16) in the driving position so as to deflect the air when driving the vehicle (10), at least a portion of the support (20), called the useful portion (24), being partially reflective and having a non-zero curvature so as to form a concave mirror on the rider's side (16),
b. an emission unit (22) for control information of the vehicle (10), the emission unit (22) being apt to emit at least one light beam, the emission unit (22) having at least one operating mode, called the head-up display mode,
the emission unit (22) and the support (20) being positioned in the display device according to positioning constraints, the positioning constraints being such that, in the head-up display mode:
the light beam emitted by the emission unit (22) is reflected onto the useful portion (24) of the support (20) so as to form a virtual image (IM) in the field of vision of the rider (16) in the driving position, and
the virtual image (IM) formed is the same image for the right eye and the left eye of the rider (16).

2. The device (12) according to claim 1, wherein the support (20) has an inclination, called the main inclination (α_{P}), with respect to the vertical, the emission unit (22) being inclined relative to the support (20) by an inclination, called the relative inclination (α_{R}), the positioning constraints stipulating that the main inclination (α_{P}) and the relative inclination (α_{R}) are such that the light beam emitted by the emission unit (22) and reflected onto the useful portion (24) forms the virtual image (IM) in the field of vision of the rider (16) in the driving position.

3. The device (12) according to claim 1, wherein the concave mirror has an apex(S) and a focus (F), the positioning constraints stipulating that the emission unit (22) is positioned on the rider side in a zone between the apex(S) of the concave mirror and a reference point (P), the positioning constraints stipulating that the reference point (P) is a point located between the vertex(S) and the focus (F) of the concave mirror positioned on the straight line connecting the vertex(S) and the focus (F) of the concave mirror so that the virtual image (IM) formed in the field of vision of the rider (16) in the driving position is the same image for the right eye and left eye of the rider (16).

4. The device (12) according to claim 3, wherein the concave mirror has a radius of curvature (R), the position of the reference point (P) depending on the radius of curvature (R) of the concave mirror.

5. The device (12) according to claim 4, wherein the distance between the reference point (P) and the vertex(S) of the concave mirror is called useful distance (d), the positioning constraints stipulating that the useful distance (d) satisfies the following relation:
$$d = - A . {R}^{2} + B . R + C$$
Where:
d is the useful distance,
R is the radius of curvature of the concave mirror, and
A, B and C are positive numbers.

6. The device (12) according to claim 1, wherein the concave mirror has a radius of curvature (R), the radius of curvature (R) being such that the virtual image (IM) has a magnification strictly greater than one.

7. The device (12) according to claim 1, wherein the emission unit (22) has another mode of operation, called the direct display mode, such that the information emitted by the emission unit (22) is directly readable by the rider (16) on the emission unit (22) when the rider (16) in the driving position is looking at the emission unit (22).

8. The device (12) according to claim 7, wherein the direct display mode and the head-up display mode correspond to different relative inclinations of the emission unit (22) relative to the support (20).

9. The device (12) according to claim 8, wherein the display device (12) comprises a pivoting mechanism apt to pivot the emission unit (22) between the head-up display mode and the direct display mode.

10. A driving assembly comprising:
a. a vehicle (10) with a handlebar (14), such as a motorcycle or scooter, and
b. a display device (12) according to claim 1, the display device (12) being integrated into the vehicle (10) so as to be positioned opposite the upper part of the body of the rider (16) in the driving position to deflect air during the driving of the vehicle (10) and to display control information of the vehicle (10) by forming a virtual image (IM) in the field of vision of the rider (16) in the driving position, the virtual image (IM) formed being the same image for the right eye and the left eye of the rider (16).

11. A method of designing a head-up display device (12) according to claim 1 for a vehicle (10) with a handlebar (14), such as a motorbike or a scooter, the method comprising the following steps:
a. obtaining the rider features relating to a rider (16) in the driving position in the vehicle (10),
b. supplying a support (20) suitable for being positioned opposite the upper part of the body of the rider (16) in the driving position, at least a portion of the support (20), called the useful portion (24), being partially reflective and having a non-zero curvature so as to form a concave mirror on the rider's side, the curvature of the support (20) having been determined according to the rider's features,
c. supplying an emission unit (22) for the control information of the vehicle (10), the emission unit (22) being apt to emit at least one light beam, the emission unit (22) having at least one operating mode, called the head-up display mode, and
d. positioning the support (20) and the emission unit (22) in the display device (12) according to positioning constraints, the positioning constraints being such that, in the head-up display mode, the light beam emitted by the emission unit (22) is reflected onto the useful portion (24) in such a way that a virtual image (IM) is formed in the field of vision of the rider (16) in the driving position, the virtual image (IM) formed is the same image for the right eye and the left eye of the rider (16).
